(19) United States
(12) Patent Application Publication
(10) Pub. No.: US 2017/0076337 A1
(43) Pub. Date: Mar. 16, 2017

(54) SYSTEM AND TOOLS FOR ORGANIZING AND RUNNING FUNDRAISING CAMPAIGNS

(71) Applicant: Katherine Brooks, Zionsville, IN (US)

(72) Inventor: Katherine Brooks, Zionsville, IN (US)

(21) Appl. No.: 15/219,129

(22) Filed: Jul. 25, 2016

Related U.S. Application Data
(60) Provisional application No. 62/196,694, filed on Jul. 24, 2015.

(51) Int. Cl. G06Q 30/02

(52) U.S. Cl. CPC G06Q 30/0279

(57) ABSTRACT

A method of running a fundraising campaign is provided. The method includes setting a fundraising goal for the campaign. The method also includes adjusting characteristics of the campaign. The characteristics of the campaign are adjusted to select a plurality of dollar amounts that may be contributed to the campaign. The characteristics of the campaign are further adjusted to select a number of times that each of the plurality of dollar amounts may be contributed to the campaign. The method also includes opening the fund raising campaign to contributors so that contributors can select one of the plurality of dollar amounts.

### CROSS-REFERENCE TO RELATED APPLICATIONS

The present application is a non-provisional of, and claims priority to, U.S. Provisional Patent Application Ser. No. 62/196,694, filed Jul. 24, 2015, and titled “SYSTEM AND TOOLS FOR ORGANIZING AND RUNNING FUNDRAISING CAMPAIGNS”, which is herein incorporated by reference in its entirety.

### BACKGROUND

Generally, fundraisers are implemented to achieve the largest contributions possible. Often, the desire for large contributions dissuades individuals from donating any amount. There is a need for fundraising that enables individuals to contribute at a level at which they are comfortable and can afford. For example, if 200 people were asked to line up and count off, “1, 2, 3 . . . 199, 200”, and each of those people gave their number in dollars, a fundraiser would raise $20,100 without anyone giving give more than $200 and with some people giving as little as a dollar.

Current online fundraising depends on masses giving small contributions to a cause. A need remains for a method that guides people to give in a series, allowing them to place themselves in a spot that makes financial sense for them, knowing that “small” is a relative term. To one person “small” could mean a dollar and to another it could mean $500. A need remains for a model that allows people to give strategically by picking their place based on their capability and passion for the project.

### SUMMARY

In one aspect, a non-transitory computer readable medium having instructions thereon is provided. The instructions are configured to instruct a processor to run a fundraising campaign through the steps of setting a fundraising goal for the campaign via a campaign initiator interface and adjusting characteristics of the campaign via the campaign initiator interface. The characteristics of the campaign are adjusted to select a plurality of dollar amounts that may be contributed to the campaign. The characteristics of the campaign are further adjusted to select a number of times that each of the plurality of dollar amounts may be contributed to the campaign. The processor is also instructed to open the fund raising campaign to contributors so that contributors can select one of the plurality of dollar amounts via a contributor interface.

In one aspect, a method of running a fundraising campaign is provided. The method includes setting a fundraising goal for the campaign. The method also includes adjusting characteristics of the campaign. The characteristics of the campaign are adjusted to select a plurality of dollar amounts that may be contributed to the campaign. The characteristics of the campaign are further adjusted to select a number of times that each of the plurality of dollar amounts may be contributed to the campaign. The method also includes opening the fund raising campaign to contributors so that contributors can select one of the plurality of dollar amounts.

### BRIEF DESCRIPTION OF THE DRAWINGS

The features and advantages of this disclosure, and the manner of attaining them, will be more apparent and better understood by reference to the following descriptions of the disclosed methods and systems, taken in conjunction with the accompanying drawings. The components in the figures are not necessarily to scale, emphasis instead being placed upon illustrating the principles of the disclosure.

FIG. 1 shows a graphical user interface according to at least one embodiment of the present disclosure.

FIG. 2 shows a graphical user interface according to at least one embodiment of the present disclosure.

FIG. 3 is an architecture diagram showing components of a system formed in accordance with at least one embodiment.

### DESCRIPTION

The present application discloses various system and tools for organizing and running fundraising campaigns. For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

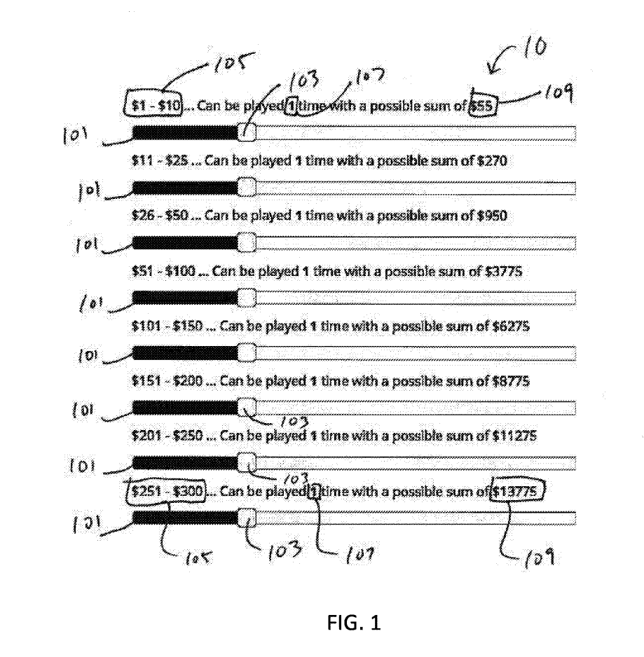

FIG. 1 shows graphical user interface 10 according to at least one embodiment of the present disclosure. Shown in FIG. 1 are a plurality of slider bars 101, each of which comprises a slider 103, range indicator 105, counter 107, and sum display 109. As shown in FIG. 1, each slider 101 is associated with a predetermined dollar range as shown in its associated range indicator 105.

According to at least one embodiment of the present disclosure, when a user of graphical user interface 10 moves slider 103 left or right along slider bar 101, counter 107 changes. As a user of graphical user interface 10 moves slider 103 left along slider bar 101, counter 107 decreases, with 1 being the lower bound of counter 107. As a user of graphical user interface 10 moves slider 103 right along slider bar 101, counter 107 increases.

According to at least one embodiment of the present disclosure, each individual dollar amount within the dollar range as shown in a range indicator 105 may be donated to a fundraising campaign as many times as is shown in the counter 107 associated with that dollar range. According, as counter 107 changes by virtue of the movement of slider 103, the figure displayed in sum display 109 changes.

As shown in FIG. 1, range indicators 105 are broken down into the following ranges:
$1-$10
$11-$25
$26-$50
$51-$100
$101-$150
$151-$200
$201-$250
$251-$300
$300-$350

However, the scope of the present disclosure is not limited to these ranges. For example, it is within the scope of the present disclosure to have ranges above $300-$350. In at least one embodiment of the present disclosure, the following ranges are available and are displayed as range indicators 105:
$1-$10
$11-$25
$26-$50
$51-$100
$101-$150
$151-$200
$201-$250
$251-$300
$300-$350
$351-$400
$401-$450
$451-$500
$501-$600
$601-$700
$701-$800
$801-$900
$901-$1000

It also is within the scope of the present disclosure that available contribution amounts within each dollar range as shown in a range indicator 105 increment by a factor other than $1. For example, it is within the scope of the present disclosure that the available contribution amounts within the dollar range $1-$10 could be $2, $4, $6, $8, and $10. As another example, it is within the scope of the present disclosure that the available contribution amounts within the dollar range $26-$50 could be $30, $35, $40, $45, and $50. As yet another example, it is within the scope of the present disclosure that the available contribution amounts within the dollar range $501-$600 could be $520, $540, $560, $580, and $600. As yet another example, it is within the scope of the present disclosure that the available contribution amounts within the dollar range $1001-$1500 could be $1100, $1200, $1300, $1400, and $1500. The foregoing are only examples, and a system according to the present disclosure may be flexibly adapted along these lines to meet the needs of the practitioner under a specific set of circumstances.

According to the method for running a fundraising campaign embodied in the present disclosure and graphical user interface 10, each dollar amount shown in a range indicator 105 can be contributed as many times as is indicated by the number in the counter 107. In at least one embodiment, the fundraising campaign process begins with a fundraising goal set by the fundraising campaign initiator. For example, if the fundraising campaign initiator sets a fundraising goal is $500,000, graphical user interface 10 would display range indicators from $1 to $1000. This is because if each dollar amount from $1 to $1000 is donated one time, the organization will raise $500,500 and no individual donation will need to exceed $1000.

The slider bars 101 can be adjusted to adjust the characteristics of the fundraising campaign. For example, if the fundraising campaign initiator understands that the fundraising support is likely to come from a population of those with little money, the fundraising campaign initiator can eliminate the higher dollar ranges (for example, the entire range can be turned off) and increase the number of times each dollar amount can be contributed in the lower dollar ranges. For example, the fundraising campaign initiator can move the slider 103 for such desired ranges further to the right so that the number displayed in counter 107 for that range is greater than 1 (for example, 5). The total for each range that will be received if all fundraising amounts are contributed for that range will be shown automatically in sum display 109. Each dollar amount within that range may be donated as many times as is shown in counter 107. After that number of individual donations for that dollar amount have been reached, the donor will be required to choose a different donation amount. Optionally, the donor also can add to the donated amount at checkout.

In another example, if the fundraising campaign initiator understands that the fundraising support is likely to come from a population of those with more money to donate, the fundraising campaign initiator can eliminate the lower dollar ranges (for example, the entire range can be turned off), and increase the number of times each dollar amount can be contributed in the higher dollar ranges. For example, if dollar ranges below $100 are “turned off,” and the number shown in each shown in counter 107 for each dollar amount between $100 and $1000 is 1, if all 900 dollar amounts are donated the fundraising campaign will raise $495,450.

In one embodiment, the fundraising campaign initiator may also be asked to provide a story behind the fundraising campaign. Additionally, the fundraising campaign initiator may be asked to provide a category for the campaign, for example, animals; children; veterans; health; education; poverty; or the like. This category may be used in the future by donors to select a fundraiser. In one embodiment, the fundraising campaign initiator may also provide images, videos, URL links, or the like that are related to the campaign. The fundraising campaign initiator may also be asked to provide an end date for the campaign.

When a donor enters the fundraising system, the donor may search for a fundraiser using word searches or category searches. The donor may then be asked to select a range for their donation, for example $11-$25; $26-$50; $51-$100, or the like. After selecting a range, dollar amounts within the range may be available for the donor to select. After each dollar amount within the range is accounted for, the range may be closed to future donors.

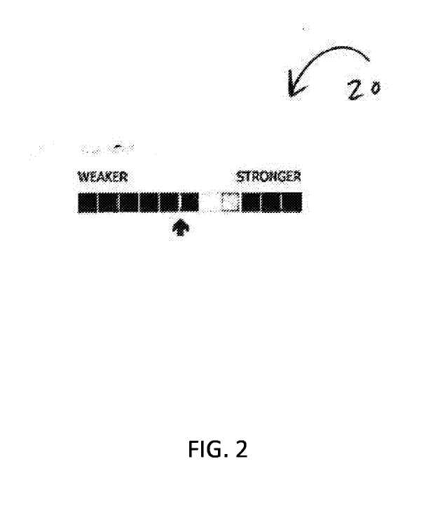

FIG. 2 shows graphical user interface 20. Graphical user interface 20 comprises an algorithmically driven “Success Tool” according to at least one embodiment of the present disclosure. The Success Tool shown in FIG. 2 is designed to measure the likelihood of success of a fundraising campaign based on weighting given to answers of a series of questions posed to the fundraising campaign initiator, including, for example:
How many potential donors do you have in your database?
How many people do you have following you on Facebook, Twitter, Instagram, and LinkedIn?
How far in advance do you plan to promote the launch of your campaign?
Do you have your top 10% of gifts pre-committed?
Will you target 90% more people than you need to reach your goal?
Do you have a communication/marketing plan for your campaign?
Do you have a marketing video for your campaign?
Do you have marketing pictures for your campaign?
Do you have a thank you plan for your donors?
What percentage of your donors regularly give or shop online?
Will you be posting 3-5 times a day on your social media to promote your campaign, updates, and general info about your work with the link to the campaign?
Do 75% or more of your donors give online?
Will you spend at least a month preparing for the public launch of your campaign (creating videos, photos, posts, building social media followers and building a team that will own portions of the campaign)?
Have you built a team to help promote the campaign through various channels?

As the fundraising campaign initiator completes the questions, the Success Tool shown in FIG. 2 will automatically adjust to show their likelihood of success of the succeeding fundraising campaign. A low score will not prohibit the fundraising campaign initiator from launching the fundraising campaign, but hopefully it will make them stop and revamp fundraising campaign for more likely success. In at least one embodiment, the Success Tool will also be intuitive, revising its assessment of the fundraiser initiators answers based on past failure or success rates of similar campaigns.

According to at least one embodiment of the present disclosure, system and tools for organizing and running fundraising campaigns may comprise an Influencer Score based on, for example, a user's sharing of fundraising campaigns, a user's giving to fundraising campaigns, and/or a user's starting fundraising campaigns. In at least one embodiment, such an Influencer Score will also track a user's likes and dislikes as a component of the Influencer Score, and make recommendations for fundraising campaigns on Influencer Score or a component thereof. In at least one embodiment, a user may receive “Badges” or other electronic award indicia based on the user's Influencer Score and/or other activities relating to fundraising campaigns. In at least one embodiment, such “Badges” will interface with third party social media platforms such as Facebook, Twitter, Instagram, LinkedIn and/or the like.

According to at least one embodiment of the present disclosure, system and tools for organizing and running fundraising campaigns may include games designed to increase charitable gift size and/or frequency, or designed to raise additional awareness and funds for the organizations undertaking fundraising campaigns.

According to at least one embodiment of the present disclosure, system and tools for organizing and running fundraising campaigns may include enterprise software functionality. In an embodiment, such functionality facilitates use of system and tools according to the present disclosure by national or multinational chapter based charitable organizations. For example, such an embodiment may include functionality for donor management, for competition between chapters, and for routine (e.g., monthly) giving, to name a few nonlimiting examples.

The various capabilities, functions, functionality, and features of a system and tools for organizing and running fundraising campaigns according to the embodiments disclosed herein and the various configuration and programming recited herein and in the claims may be performed by computer software and/or computer hardware. Such computer software may be written in a well-known language such as, for example, Basic, C, C++, Fortran, JavaScript, Java, Pascal, PERL, HTML, XML, Python, Jango, or SQL, or a combination of any of the foregoing or the equivalents thereof. At least one embodiment may be developed as a Microsoft ASP.NET web application.

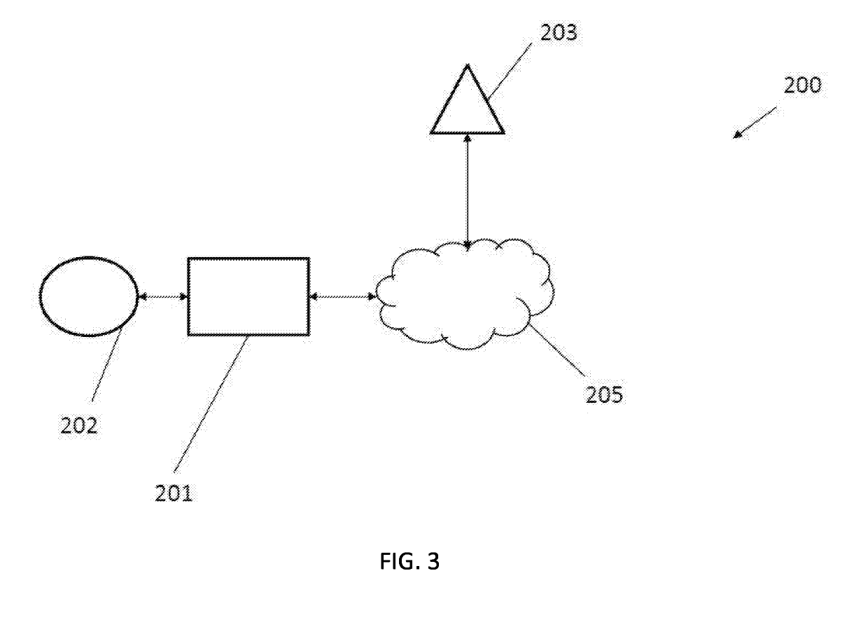

Referring now to FIG. 3, it is shown an architecture diagram detailing components of a system 200 according to at least one embodiment of the present disclosure. System 200 comprises user device 203, server 201, database 202, and computer network 205. For purposes of clarity, only one user device 203 is shown in FIG. 3. However, it is within the scope of the present disclosure that the system 200 may any number of user devices 203 at one time.

The user device 203 may be configured to transmit information to and generally interact with a web services infrastructure housed on server 201 over computer network 205. The user device 203 may include a web browser, mobile application, or other network connected software such that communication with the web services infrastructure on server 201 is possible over the computer network 205. User device 203 includes one or more computers, smartphones, tablets, wearable technology, computing devices, or systems of a type well known in the art, such as a mainframe computer, workstation, personal computer, laptop computer, hand-held computer, cellular telephone, or personal digital assistant. User device 203 comprises such software, hardware, and componentry as would occur to one of skill in the art, such as, for example, one or more microprocessors, memory systems, input/output devices, device controllers, and the like. User device 203 also comprises one or more data entry means (not shown in FIG. 3) operable by users of user device 203 for data entry, such as, for example, a pointing device (such as a mouse), keyboard, touchscreen, microphone, voice recognition, and/or other data entry means known in the art. User device 203 also comprises a display means (not shown in FIG. 3) which may comprise various types of known displays such as liquid crystal diode displays, light emitting diode display, and the like upon which information may be display in a manner perceptible to the user.

As described above, the server 201 may be configured to receive username and password, biographical information, images, content, and other information from the user device 203 to establish a profile and assorted content for someone's life. In at least one embodiment, the server 201 accesses the database 202 to store information, content and other data transmitted from the user device 203 or generated through its interaction with the server 201 in the methods and disclosed herein. The server 201 is configured to carry out one or more of the steps of methods described herein.

The user device 203 is further configured to provide input to the server 201 to carry out one or more of the steps of the methods described herein. Server 201 comprises one or more server computers, computing devices, or systems of a type known in the art. Server 201 further comprises such software, hardware, and componentry as would occur to one of skill in the art, such as, for example, microprocessors, memory systems, input/output devices, device controllers, display systems, and the like. Server 201 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 3, server 201 is shown and referred to herein as a single server. However, server 201 may comprise a plurality of servers, virtual infrastructure, or other computing devices or systems interconnected by hardware and software systems know in the art which collectively are operable to perform the functions allocated to server 201 in accordance with the present disclosure.

The database 202 is configured to store biographical data, content, and other information. Database 202 is “associated with” server 201. According to the present disclosure, database 202 can be “associated with” server 201 where, as shown in the embodiment in FIG. 3, database 202 resides on server 201. Database 202 can also be “associated with” server 201 where database 202 resides on a server or computing device remote from server 201, provided that the remote server or computing device is capable of bi-directional data transfer with server 201, such as, for example, in Amazon AWS, Rackspace, or other virtual infrastructure, or any business network. In at least one embodiment, the remote server or computing device upon which database 202 resides is electronically connected to server 201 such that the remote server or computing device is capable of continuous bi-directional data transfer with server 201.

For purposes of clarity, database 202 is shown in FIG. 3, and referred to herein as a single database. It will be appreciated by those of ordinary skill in the art that database 202 may comprise a plurality of databases connected by software systems of a type well known in the art, which collectively are operable to perform the functions delegated to database 202 according to the present disclosure. Database 202 may comprise a relational database architecture or other database architecture of a type known in the database art. Database 202 may comprise one of many well-known database management systems, such as, for example, MICROSOFT's SQL Server, MICROSOFT's ACCESS, or IBM's DB2 database management systems, or the database management systems available from ORACLE or SYBASE. Database 202 retrievably stores information that is communicated to database 202 from user device 203 or server 201.

User device 203 and server 201 communicate via computer network 205. If database 202 is in disparate infrastructure from server 201, database 202 may communicate with server 201 via computer network 205. Computer network 205 may comprise the Internet, but this is not required.

While this disclosure has been described as having a preferred design, the systems and methods according to the present disclosure can be further modified within the scope and spirit of this disclosure. This application is therefore intended to cover any variations, uses, or adaptations of the disclosure using its general principles. For example, the methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains and which fall within the limits of the appended claims.

I claim:

1. A non-transitory computer readable medium having instructions thereon, the instructions configured to instruct a processor to run a fundraising campaign through the steps of:
setting a fundraising goal for the campaign via a campaign initiator interface;
adjusting characteristics of the campaign via the campaign initiator interface, wherein the characteristics of the campaign are adjusted to select a plurality of dollar amounts that may be contributed to the campaign, wherein the characteristics of the campaign are further adjusted to select a number of times that each of the plurality of dollar amounts may be contributed to the campaign; and
opening the fund raising campaign to contributors so that contributors can select one of the plurality of dollar amounts via a contributor interface.

2. The non-transitory computer readable medium of claim 1 further configured to instruct the processor to adjust the characteristics of the campaign by eliminating at least one of the plurality of dollar amounts.

3. The non-transitory computer readable medium of claim 2 further configured to instruct the processor to adjust the characteristics of the campaign by adjusting the number of times that each of the plurality of dollar amounts may be contributed based on the elimination of at least one of the plurality of dollar amounts.

4. The non-transitory computer readable medium of claim 1 further configured to instruct the processor to close at least one of the plurality of dollar amounts once the number of times that the at least one of the plurality of dollar amounts may be contributed is reached.

5. The non-transitory computer readable medium of claim 1 further configured to instruct the processor to adjust the characteristics of the campaign using a slider bar on the campaign initiator interface.

6. The non-transitory computer readable medium of claim 1 further configured to instruct the processor to track an influence score of the contributor based on activities of the contributor.

7. The non-transitory computer readable medium of claim 6 further configured to instruct the processor to recommend to the contributor additional campaigns based on the influence score of the contributor.

8. The non-transitory computer readable medium of claim 1 further configured to instruct the processor to determine a likelihood of success of the campaign.

9. The non-transitory computer readable medium of claim 8 further configured to instruct the processor to determine the likelihood of success based on a plurality of questions presented at the campaign initiator interface.

10. The non-transitory computer readable medium of claim 8 further configured to instruct the processor to determine the likelihood of success based on a comparison of the campaign to previous campaigns.

11. A method of running a fundraising campaign comprising:
setting a fundraising goal for the campaign;
adjusting characteristics of the campaign, wherein the characteristics of the campaign are adjusted to select a plurality of dollar amounts that may be contributed to the campaign, wherein the characteristics of the campaign are further adjusted to select a number of times that each of the plurality of dollar amounts may be contributed to the campaign; and
opening the fund raising campaign to contributors so that contributors can select one of the plurality of dollar amounts.

12. The method of claim 11 further comprising adjusting the characteristics of the campaign by eliminating at least one of the plurality of dollar amounts.

13. The method of claim 12 further comprising adjusting the characteristics of the campaign by adjusting the number of times that each of the plurality of dollar amounts may be contributed based on the elimination of at least one of the plurality of dollar amounts.

14. The method of claim 11 further comprising closing at least one of the plurality of dollar amounts once the number of times that the at least one of the plurality of dollar amounts may be contributed is reached.

15. The method of claim 11 further comprising adjusting the characteristics of the campaign using a slider bar on a user interface.

16. The method of claim 11 further comprising tracking an influence score of the contributor based on activities of the contributor.

17. The method of claim 16 further comprising recommending to the contributor additional campaigns based on the influence score of the contributor.

18. The method of claim 11 further comprising determining a likelihood of success of the campaign.

19. The method of claim 18 further comprising determining the likelihood of success based on a plurality of questions presented at the campaign initiator interface.

20. The method of claim 18 further comprising determining the likelihood of success based on a comparison of the campaign to previous campaigns.
